(19) United States
(12) Patent Application Publication
(10) Pub. No.: US 2005/0110914 A1
(43) Pub. Date: May 26, 2005

(54) Portable TV-navigation system

(75) Inventor: Jung Hoon Lee, Kyunggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Yongin-shi (KR)

(21) Appl. No.: 10/747,444

(22) Filed: Dec. 30, 2003

(30) Foreign Application Priority Data
Nov. 20, 2003 (KR) 2003-82672

(51) Int. Cl. H04N 5/64

(52) U.S. Cl. 348/838

(57) ABSTRACT

A portable TV-navigation system includes a liquid crystal display panel, a TV board, a navigation board and a case panel. The TV board is mounted on a rear surface of the liquid crystal display panel to receive a TV signal and control an image outputted from the liquid crystal display panel. The navigation board is mounted on a rear surface of the TV board to receive a GPS signal and output an image signal relating to a vehicle position to the liquid crystal display panel. The case panel is mounted on a rear surface of the navigation board. This system allows a TV and a navigation system to be integrated into a single unit, while enabling the navigation system to be put on and taken off in the same fashion as an in-vehicle TV. Particularly, since the navigation system uses a CF memory chip, the navigation operating rate is increased and the system volume is reduced.

### RELATED APPLICATION

The present disclosure relates to subject matter contained in Korean Application No. 10-2003-82672, filed on Nov. 20, 2003, which is herein expressly incorporated by reference in its entirety.

### BACKGROUND OF THE INVENTION

1. Field of the Invention

The present invention relates to a portable TV-navigation system, and more particularly to a portable TV-navigation system wherein a navigation board is mounted on a TV installed in a vehicle so that when the vehicle is replaced with a new one, the TV and navigation system can be installed in the new vehicle.

2. Description of the Related Art

A vehicle location system, i.e., a car navigation system, is a device that uses various sensors and radio signals transmitted from a GPS (Global Positioning System) satellite to display the current position of a vehicle on a digital road map, set a destination of the vehicle, and provide a voice guide of a route to the set destination.

In brief, the GPS as a basis for car navigation is an all-weather location system that can receive information sent from a satellite and detect the position of a stationary or moving object at any location of the earth. The GPS system usually employs triangulation using three or four satellites to calculate the current position of a vehicle or person. This GPS system has been developed and operated by the United States.

FIG. 1 is a block diagram schematically showing the configuration of such a conventional navigation system.

As shown in this figure, the conventional navigation system includes a GPS receiver 1, a gyro sensor 2, an A/D converter 3, a CPU 4 and an external navigation board 5. The GPS receiver 1 transmits and receives data to and from a satellite through an antenna. When a vehicle is located in a terrain or location where data cannot be transmitted and received through the GPS receiver 1, the gyro sensor 2 calculates the horizontal position of the vehicle to make it possible to locate the vehicle. The A/D converter 3 is connected to the gyro sensor 2. The CPU 4 is connected to the A/D converter 3 and the GPS receiver 1. Based on information received from the GPS receiver 1 and the A/D converter 3, the CPU 4 calculates the position information of the vehicle, and outputs it to a display unit of the navigation board 5 or the like.

In the case where satellite information of the vehicle is not received through the GPS receiver 1, the CPU 4 performs a dead reckoning (DR) function based on information that is outputted from the gyro sensor 2 and then digitized through the A/D converter 3. In other words, in the case where the satellite information of the vehicle is not received, the CPU 4 calculates the vehicle's position based on a signal detected by the gyro sensor 2. In addition, as circumstances require, even when the satellite information is received, the CPU may modify it based on the signal detected by the gyro sensor 2.

However, such a conventional navigation system configured as described above has a problem in that when the vehicle is replaced with a new one, the navigation system cannot be moved to the new vehicle since the CPU or GPS receiver is built into a rack of the vehicle.

In addition, for the purpose of calculating the position of a vehicle, the conventional navigation system includes therein a memory for storing map data containing facility information. Generally, a CD or DVD for storing general media type data is used as the memory. However, the use of the CD or DVD causes the system to be spatially restricted and also to suffer from a time delay due to the media load time.

### SUMMARY OF THE INVENTION

Therefore, the present invention has been made in view of the above problems, and it is an object of the present invention to provide a portable TV-navigation system, wherein a navigation board is integrated with a TV installed in a vehicle, and the navigation board provides the geographical information of the vehicle on the basis of data stored in a CF memory chip, so as to improve the system's portability.

In accordance with the present invention, the above and other objects can be accomplished by the provision of a portable TV-navigation system comprising: a liquid crystal display panel; a TV board, mounted on a rear surface of the liquid crystal display panel, for receiving a TV signal and controlling an image outputted from the liquid crystal display panel; a navigation board, mounted on a rear surface of the TV board, for receiving a GPS signal and outputting an image signal relating to a vehicle position to the liquid crystal display panel; and a case panel mounted on a rear surface of the navigation board.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a conventional navigation system;

FIG. 2 shows the external appearance of a portable TV-navigation system according to the present invention;

FIG. 3 shows the configuration of the portable TV-navigation system according to the present invention; and

FIG. 4 is a block diagram showing a more detailed configuration of a TV board and a navigation board shown in FIG. 3.

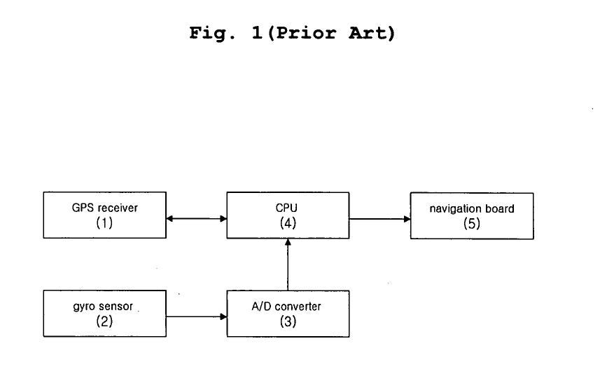

### DESCRIPTION OF THE PREFERRED EMBODIMENTS

Now, preferred embodiments of the present invention will be described in detail with reference to the annexed drawings.

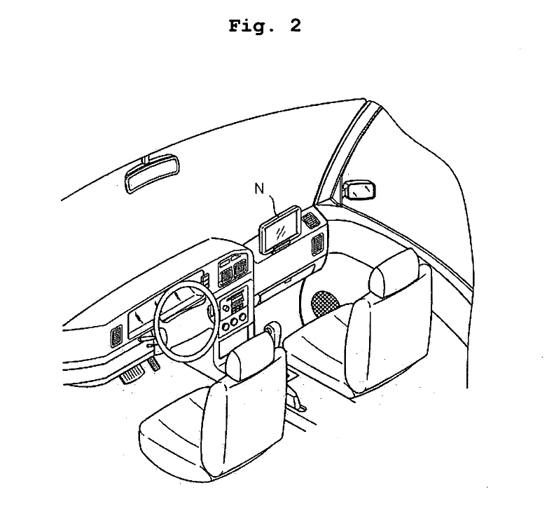

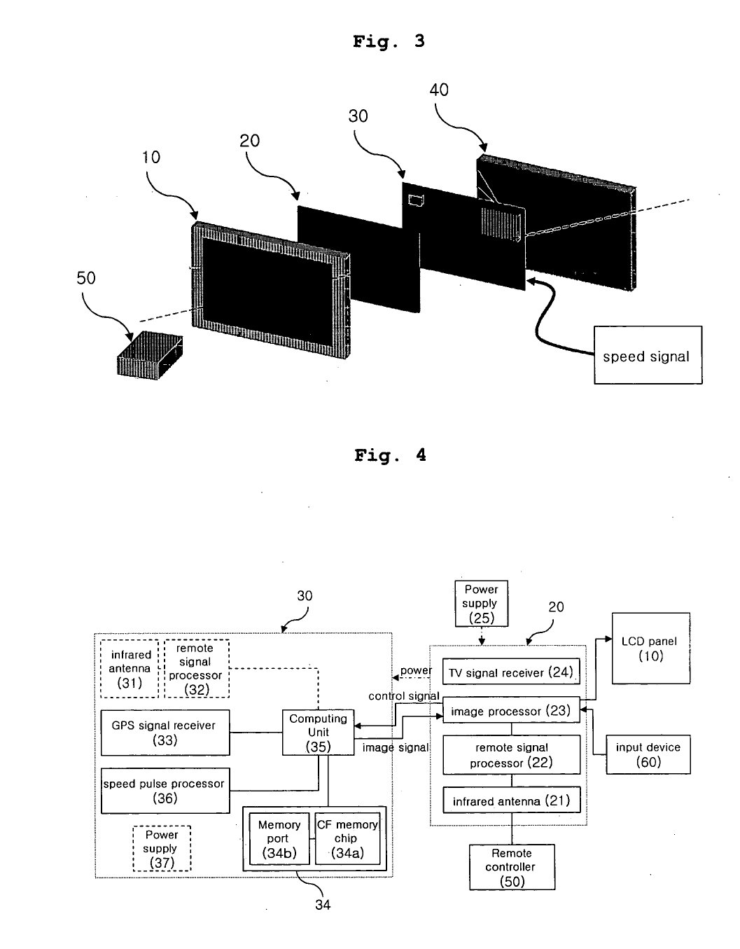

The external appearance N of a portable TV-navigation system according to the present invention is shown in FIG. 2. As shown in FIG. 3, the portable TV-navigation system includes a liquid crystal display (LCD) panel 10, a TV board 20, a navigation board 30, and a case panel 40. The LCD panel 10 includes front and rear panels, and displays a screen by light emitted from a fluorescent substance coated between the front and rear panels. The TV board 20 outputs image signals corresponding to received TV signals to the LCD panel 10. The navigation board 30 is mounted on a rear surface of the TV board 20, and allows the position information of a vehicle to be displayed on the LCD panel 10 after passing through the TV board 20. The case panel 40 is mounted on a rear surface of the navigation board 30.

The portable TV-navigation system according to the present invention may further include an infrared remote controller 50, as shown in FIG. 3, which can transmit a remote control signal to the TV board 20 or to the navigation board 30.

When a user of the portable TV-navigation system according to the present invention operates the remote controller 50 to input a control command for turning on/off the navigation or TV mode or a control command for controlling the output screen, the TV or navigation board 20 or 30 receives an IR (infrared) signal transmitted from the remote controller 50 through an IR signal antenna (not shown) mounted on the TV or navigation board 20 or 30.

In the meantime, when a signal relating to a vehicle speed is inputted to the navigation board 30 as shown in FIG. 3, the navigation board 30 analyzes the position information of the vehicle on the basis of the inputted signal or a signal received through a GPS antenna, and produces an image signal corresponding to the position information and outputs it to the TV board 20.

The TV board 20 processes the image signal outputted from the navigation board 30 so that it is displayed on the LCD panel 10.

FIG. 4 is a block diagram showing a more detailed configuration of the TV and navigation boards 20 and 30 in the portable TV-navigation system according to the present invention.

In this embodiment, a control signal transmitted from the remote controller 50 is inputted to the TV board 20, and the TV board 20 transfers the inputted control signal to the navigation board 30 if it is a control signal relating to the navigation board 30. However, as circumstances require, the navigation board 30 may further include an infrared antenna 31 and a remote signal processor 32 so that it receives a standardized infrared signal transmitted from the remote controller 50 and performs the corresponding signal processing.

The TV board 20 includes an infrared antenna 21, a remote signal processor 22, an image processor 23 and a TV signal receiver 24. The infrared antenna 21 receives a control signal transmitted from the remote controller 50. The remote signal processor 22 processes data received through the infrared antenna 21 and outputs it to the image processor 23 that produces and outputs an image signal for the TV board.

The TV signal receiver 24 receives a TV signal through a TV antenna or the like. In order for the LCD panel 10 to perform a display operation on the basis of the signal received through the TV signal receiver 24, the image processor 23 produces a corresponding image signal and outputs it to the LCD panel 10, while controlling an image outputted from the LCD panel 10.

The image processor 23 in the TV board 20 also processes an image signal outputted from the navigation board 30 so that the corresponding image is displayed on the LCD panel 10.

If a remote control signal received from the remote controller 50 is a TV related control signal, the image processor 23 processes an image signal on the basis of the received signal to control the output of the LCD panel 10. On the other hand, if the remote control signal is a navigation related control signal, the image processor 23 transfers it to the navigation board 30.

In other words, if it can process or handle a remote control signal received from the remote controller 50, the image processor 23 processes an image signal on the basis of the received signal; otherwise, it transfers the received remote control signal to the navigation board 30.

The navigation board 30 includes a GPS signal receiver 33, a memory 34 and a computing unit 35. The GPS signal receiver 33 receives a GPS signal through a satellite antenna. Then, the GPS signal receiver 33 extracts the current position information of a vehicle from data extracted from the received GPS signal after performing intermediate frequency filtering on it. Map data containing facility information or the like, which is referred to when calculating the vehicle position information, is stored in the memory 34. By combining the current position information extracted at the GPS signal receiver 33 and the map data containing facility information stored in the memory 34, the computing unit 35 produces and outputs an image signal of the vehicle's geographical information.

When the image signal, corresponding to both the current position information of the vehicle and the map data containing facility information around the vehicle, is outputted to the image processor 23 in the TV board 20 through the computing unit 35 after being produced at the navigation board 30, the image processor 23 allows the LCD panel 10 to display a screen on the basis of the image signal so that the portable TV-navigation system's user may view it.

In this embodiment, the GPS signal receiver 33, the computing unit 35 and the memory 34 are described as essential elements of the navigation board 30. However, the navigation board 30 may further include a speed pulse processor 36 that receives a speed signal from a speed sensor in the vehicle, and processes the speed signal and outputs it to the computing unit 35.

In other words, the speed pulse processor 36 receives a vehicle speed pulse signal produced at a speed sensor provided in the vehicle, and outputs it to the computing unit 35 after amplifying and filtering it. When calculating the position information of the vehicle, the computing unit 35 refers to the signal relating to the vehicle speed received from the speed pulse processor 36, so as to produce and output an image signal representing a more accurate position of the vehicle.

The memory 34 includes a CF memory chip 34a and a memory port 34b as shown in FIG. 4. The memory port 34b enables the CF memory chip 34a to be put on and taken off, and also permits data stored in the CF memory chip 34a to be outputted to the computing unit 35 therethrough.

The CF memory chip 34a differs from the conventional media type disk, in that map data containing facility information stored in the CF memory chip 34a can be accessed from the computing unit 35 through the memory chip port 34b, without requiring an additional loading mechanism or time.

Accordingly, as compared to the prior art where the position information is calculated based on data recorded in a CD or DVD, the navigation board 30 according to the present invention can process data in a very short time and also has a small volume so that it can be attached to an in-vehicle TV.

In the case where the navigation board 30 is mounted on the TV board 20, it is desirable that the navigation board 30 is configured to receive power from a power supply 25 of the TV board 20, in order to achieve system integration and reduce the system's volume. However, as circumstances demand, the navigation board 30 may also be provided with a separate power supply 37 used for the navigation board 30 as shown in FIG. 4.

The portable TV-navigation system according to the present invention may further include an input device 60 such as a keypad, as shown in FIG. 4, which is connected to the TV board 20 and allows a control command to be inputted to the portable TV-navigation system. As circumstances require, the input device 60 may be composed of a touch pad or the like.

Accordingly, the portable TV-navigation system can be controlled directly through the input device 60 also in the case where it is not controlled by the remote controller 50. Particularly, the input device 60 enables the user to select whether the TV board 20 or the navigation board 30 will be permitted to output its image signal through the LCD panel 10.

In other words, if he or she desires to receive TV signals, the user can input a TV reception command to the portable TV-navigation system through the input device 60. On the other hand, if he or she desires to know the current location of a vehicle through the navigation system, the user can input a command for activating the navigation system and displaying the vehicle's position information to the portable TV-navigation system through the input device 60.

As apparent from the above description, a portable TV-navigation system according to the present invention includes a liquid crystal display panel; a TV board, mounted on a rear surface of the liquid crystal display panel, for receiving a TV signal and controlling an image outputted from the liquid crystal display panel; a navigation board, mounted on a rear surface of the TV board, for receiving a GPS signal and outputting an image signal relating to a vehicle position to the liquid crystal display panel; and a case panel mounted on a rear surface of the navigation board. This portable TV-navigation system has advantages in that it allows a TV and a navigation system to be integrated into a single unit, while enabling the navigation system to be put on and taken off in the same fashion as an in-vehicle TV. Particularly, since the navigation system uses a CF memory chip, the navigation operating rate (for example, navigation information display refresh rate) is increased and the system volume is reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A portable TV-navigation system comprising:
a liquid crystal display panel;
a TV board, mounted on a rear surface of the liquid crystal display panel, that receives a TV signal and controls an image outputted from the liquid crystal display panel;
a navigation board, mounted on a rear surface of the TV board, that receives a GPS signal and outputs an image signal relating to a vehicle position to the liquid crystal display panel; and
a case panel mounted on a rear surface of the navigation board.

2. The portable TV-navigation system according to claim 1, further comprising a remote controller that transmits a control signal to the TV board.

3. The portable TV-navigation system according to claim 2, wherein, if the transmitted control signal is a control signal relating to the navigation board, the TV board transfers the control signal to the navigation board.

4. The portable TV-navigation system according to claim 1, further comprising a speed sensor that produces a signal relating to a vehicle speed and outputs it to the navigation board.

5. The portable TV-navigation system according to claim 1, wherein the TV board includes:
a TV signal receiver that receives a TV signal through an antenna; and
an image signal processor that detects an image signal from a signal received through the TV signal receiver and processes the image signal so that it can be displayed on the liquid crystal display panel, while processing an image signal outputted from the navigation board so that it can be displayed on the liquid crystal display device.

6. The portable TV-navigation system according to claim 1, wherein the navigation board includes:
a GPS signal receiver that receives a satellite signal from a satellite antenna and extracts a vehicle's current position information from the received signal after performing intermediate frequency filtering on it;
a memory in which map data containing facility information is stored; and
a computing unit that combines the current position information extracted at the GPS signal receiver and the map data containing facility information stored in the memory to produce and output an image signal relating to geographical information of the vehicle.

7. The portable TV-navigation system according to claim 6, wherein the memory includes:
a CF memory chip; and
a memory chip port that enables the CF memory chip to be put on and taken off and allows data stored in the CF memory chip to be outputted to the computing unit therethrough.

8. The portable TV-navigation system according to claim 6, further comprising a navigation remote controller that transmits a control signal to the navigation board according to an infrared communication standard.

9. The portable TV-navigation system according to claim 8, wherein the navigation board further includes an infrared antenna; and a remote signal processor that processes data received through the antenna and outputs it to the computing unit, so as to enable the navigation board to be controlled by a remote control signal transmitted according to the infrared communication standard.

10. The portable TV-navigation system according to claim 6, wherein the navigation board further includes a speed pulse processor that receives a signal relating to a vehicle speed pulse transmitted from outside of the navigation board, and processes and outputs the received signal so as to allow the computing unit to calculate vehicle position information.

11. The portable TV-navigation system according to claim 1, wherein the navigation board is configured to receive power through the TV board.

12. The portable TV-navigation system according to claim 1, further comprising an input device, connected to the TV board, that selects whether a screen of the navigation board or a screen of the TV board will be outputted through the liquid crystal display panel.
